(19) United States
(12) Patent Application Publication
(10) Pub. No.: US 2002/0176451 A1
(43) Pub. Date: Nov. 28, 2002

(54) Erbium-doped fiber laser for long wavelength band

(75) Inventors: Donghan Lee, Daejeon (KR); Hyunbeom Choi, Gyonggi-do (KR)

Correspondence Address: GREENBLUM & BERNSTEIN, P.L.C., 1941 ROLAND CLARKE PLACE, RESTON, VA, 20191, US

(73) Assignee: NEOTEK RESEARCH CO., LTD., Seoul (KR)

(21) Appl. No.: 09/993,653

(22) Filed: Nov. 27, 2001

(30) Foreign Application Priority Data
May 8, 2001 (KR) 2001-24799

(51) Int. Cl. H01S 3/30; H01S 3/091; H01S 3/092

(52) U.S. Cl. 372/6; 372/70

(57) ABSTRACT

The present invention relates to fiber lasers for long wavelength band. More particularly, the invention relates to an Erbium-doped fiber laser for long wavelength band for lowering lasing threshold and improving the output efficiency by injecting conventional band backward Amplified Spontaneous Emission (ASE) for the design of a laser which lases in 1580 nm band.

Specifically, by positioning a reflecting means between an input terminal and the Erbium-doped fiber, some parts of conventional band backward Amplified Spontaneous Emission (ASE) is injected along with the light in long wavelength band and the laser is outputted at a pre-determined wavelength by passing through a tunable wavelength filter.

### BACKGROUND OF THE INVENTION

The present invention relates to fiber lasers for long wavelength band (L-band). More particularly, the invention relates to an erbium-doped fiber laser for long wavelength band for improving lasing threshold and output efficiency through a significant increase of the optical amplification gain for long wavelength band by injecting a 1550 nm band backward amplified spontaneous emission (ASE) along with long wavelength band signal by positioning a reflecting means between an input terminal and the pumped erbium-doped fiber.

In order to cope with the rapid increase in communication traffics, many researches are being concentrated on Wavelength Division Multiplexing (WDM) method that is capable of increasing the transmission capacity to the number of available channels by transmitting a number of channels with different wavelengths through a line of optical fiber.

Presently, commercial optical communication systems utilize the signal wavelength band between 1530 nm-1560 nm (conventional band). However, various attempts have been made for commercializing the long wavelength band between 1570 nm-1605 nm in order to handle the rapid increase in transmission traffics.

In the past, most of the studies on various fiber lasers have been focused on conventional band to use as signal sources for optical transmission systems or as test optical sources for optical devices. Recently, the need for long wavelength band in optical communication systems makes researches on optical sources in this long wavelength band important. The long wavelength band optical source will be used in all areas in which the conventional band optical sources were required.

However, this long wavelength band is the wavelength band where the gain coefficient of an Erbium-doped fiber amplifier is very small. So, in order to get a sufficient gain value in this long wavelength band it requires a long Erbium-doped fiber as well as a relatively high power pump laser. Since this has also resulted in low efficiency in long wavelength band amplifiers and an increase in the noise figure, active researches are also being pursued in this area to solve these problems.

FIG. 1 is a schematic diagram of the conventional Erbium-doped fiber laser. As illustrated in the diagram, after the inputted spontaneous emission light through a feedback and the pump laser outputted from a pump laser diode 102 are combined in a Wavelength Division Multiplexer 103, they are inputted to an Erbium-Doped Fiber (EDF) 101. In EDF 101 in the middle, the pumping laser excites Erbium that is a rare-earth ion present in EDF 101. The spontaneous emission generated in this instance is a gain inputted to EDF 101 by passing through a single wavelength determined by a tunable wavelength filter 105. The inputted signal is amplified through the stimulated emission and lases by repeating the same processes.

The conventional Erbium-doped fiber lasers as shown on the above example pose no problem in the existing conventional band usages. However, if it is to be used in long wavelength band, the length of EDF 101 gets elongated and the 980 nm pumping laser is absorbed in the very short length of the front end. Consequently, the signal amplification is possible at the front part of EDF 101 but the signal absorption can occur at the later part.

Lasing starts from amplification of very weak spontaneous emission, gain at small signal should be large enough to make it lase. However, the weak spontaneous emission may be absorbed in the very long length EDF 101 at low pumping power, resulting in a significant increase in the lasing threshold.

### SUMMARY OF THE INVENTION

The object of the present invention is to provide an Erbium-doped fiber laser for long wavelength band with an improved efficiency and a low lasing threshold by injecting a Conventional band backward amplified spontaneous emission into the pumped EDF along with the long wavelength band light by positioning a reflecting means between an input terminal and the pumped erbium-doped fiber.

### BRIEF DESCRIPTION OF THE DRAWINGS

FIG. 1 is a schematic diagram of the conventional Erbium-doped fiber laser.

FIG. 2 shows an Erbium-doped fiber laser for long wavelength band according to one embodiment of the present invention.

FIG. 3 shows the lasing threshold characteristics of an Erbium-doped fiber laser for long wavelength band according to one embodiment of the present invention.

FIG. 4 shows the output characteristics of an Erbium-doped fiber laser for long wavelength band according to one embodiment of the present invention.

From FIG. 5a to FIG. 5d show some examples of the changes in reflecting input section according to preferred embodiments of the present invention.

From FIG. 6a to FIG. 6c are diagrams which explain the examples of variation on the pumping laser generation section in FIG. 2.

From FIG. 7a to FIG. 7c are diagrams which show the changes of the filter section in FIG. 2.

FIG. 8 is a diagram which shows an example of the construction that inputs an amplified spontaneous emission in FIG. 2.

FIG. 9 is a schematic diagram which shows an Erbium-doped fiber laser for wide band according to one embodiment of the present invention.

FIG. 10 shows the characteristics of an Erbium-doped fiber laser for wide-band as shown in FIG. 9.

FIG. 11 is a schematic diagram which shows an Erbium-doped fiber laser for wide band according to other embodiment of the present invention.

FIG. 12 is a diagram which shows an Erbium-doped fiber laser for wide band according to one embodiment of the present invention.

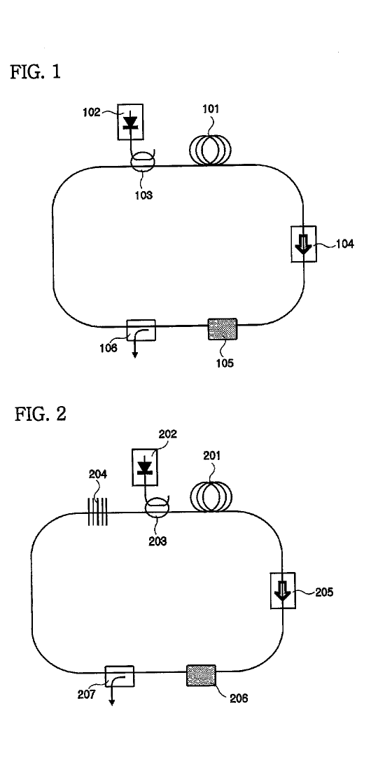

[Description of the Numeric on the Main Parts of the Drawings]

201, 251, 801: Erbium-doped fiber laser (EDF)

202, 252, 612, 631a, 631b, 802: Laser diode

203, 253, 611, 803, 911, 912: Wavelength Division Multiplexer

204, 222: fiber Bragg grating

205, 805: Isolator

206: Tunable wavelength filter

207, 211, 221, 621, 731: Coupler

212: Reflection Mirror

231: Air Gap

241: Storage Medium which faces each other

631: Laser Diode Module

711: Fabry-Perot interferometer

721: Circulator

722: Diffraction Grating

### DETAILED DESCRIPTION OF THE EMBODIMENTS

In order to achieve the previously stated objectives, the Erbium-doped fiber laser for long wavelength band according to the present invention comprises, a lasing section for lasing through a stimulated emission of an inputted laser signal; a pumping laser generation section for population inverting said lasing section by inputting a pumping laser signal generated to said lasing section; a reflecting input section for reflecting the conventional band amplified spontaneous emission signal inputted from said lasing section and passing as well as outputting the laser signal inputted by a feedback to said lasing section; a separation transmission section for outputting the laser signal output from said lasing section by allowing the laser signal to pass through one direction; a filter section for outputting a specific wavelength by filtering the specific wavelength predetermined from the laser signal inputted from said separation transmission section; and a feedback output section for outputting the laser signal inputted from said filter section and inputting some parts of the laser signal to said reflecting input section through a feedback.

Hereinafter, preferred embodiments of the Erbium-doped fiber laser for long wavelength band according to the present invention will be described in detail with reference to the accompanying drawings.

FIG. 2 shows an Erbium-doped fiber laser for long wavelength band according to one embodiment of the present invention.

As shown in FIG. 2, the Erbium-doped fiber laser for long wavelength band according to one embodiment of the present invention comprises; a EDF 201 for lasing; a laser diode 202 and a Wavelength Division Multiplexer 203; a fiber Bragg grating 204 for the reflecting input section; an isolator 205 for the separation transmission section; a tunable wavelength filter 206; and a coupler 207 for the feedback output section.

The Erbium-doped fiber laser for long wavelength band according to the present invention comprises the above components as well as a ring type resonator and the laser lases while circulating in the clockwise direction which coincides with the direction of the isolator.

The gain medium EDF 201 is excited by the pumping laser diode 202 and emits the spontaneous emission light. This emission light passes through the isolator and is filtered at the tunable wavelength filter. As a result, only specific wavelength reaches the coupler 207. The coupler 207 outputs only at a specific splitting ratio and the rest are outputted again to the ring type resonator. Afterwards, the light of specific wavelength is amplified and lases through a stimulated emission.

The fiber Bragg grating 204 is an essential part of the present invention, which reflects the conventional band backward amplified spontaneous emission prior to lasing and injects to the EDF 201 along with a low strength long wavelength band signal. This process, in which the conventional band backward amplified spontaneous emission effectively uses inverted energy at the short front section of EDF, pass through a long length EDF 201, is absorbed to give gain in the long wavelength band, and effectively increases the amplification gain of the long wavelength band, resulting in a lower lasing threshold and improvement in the amplification efficiency.

The fiber Bragg grating 204 can be also located between a Wavelength Division Multiplexer 203 and a long length EDF 201, since the pump laser beam can go through the fiber Bragg grating with almost no loss.

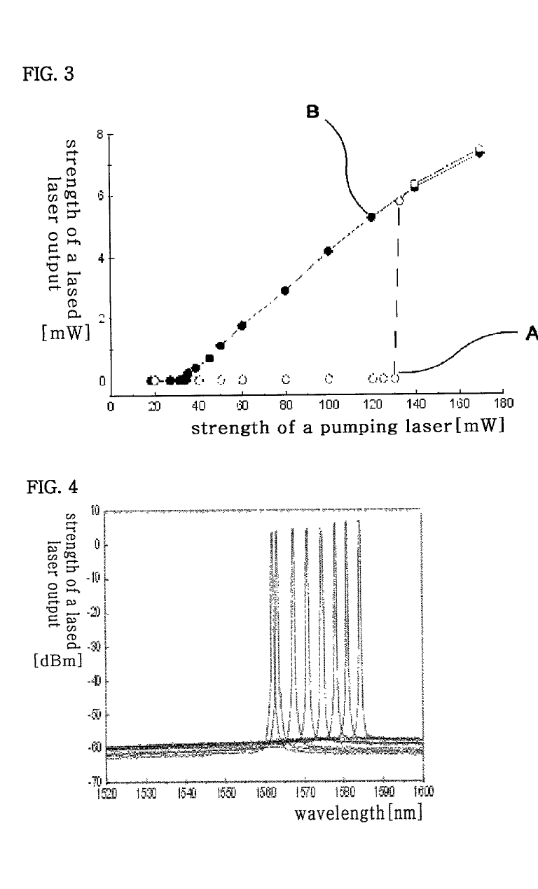

FIG. 3 shows the lasing threshold characteristics of an Erbium-doped fiber laser for long wavelength band according to one embodiment of the present invention. The lasing threshold characteristics are shown to be dependent upon the existence of the fiber Bragg grating 204. Here, the X-axis and Y-axis represent the strength of a pumping laser [mW] and the strength of a laser output [mW], respectively. In FIG. 3, the curve A represents the characteristics in the absence of the fiber Bragg grating 204 where the value of lasing threshold is 130 mW of 980 nm. On the contrary, the curve B represents the characteristics in the presence of the fiber Bragg grating 204 where the value of lasing threshold is 35 mW. The comparison on the wavelength of the fiber Bragg grating 204 shows that the value of lasing threshold becomes smaller as the reflection wavelength approaches 1560 nm from the shorter wavelength side.

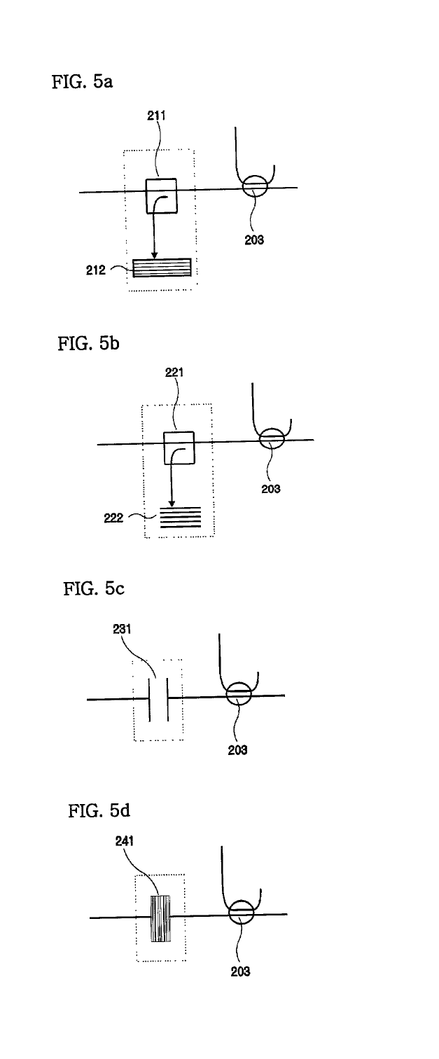

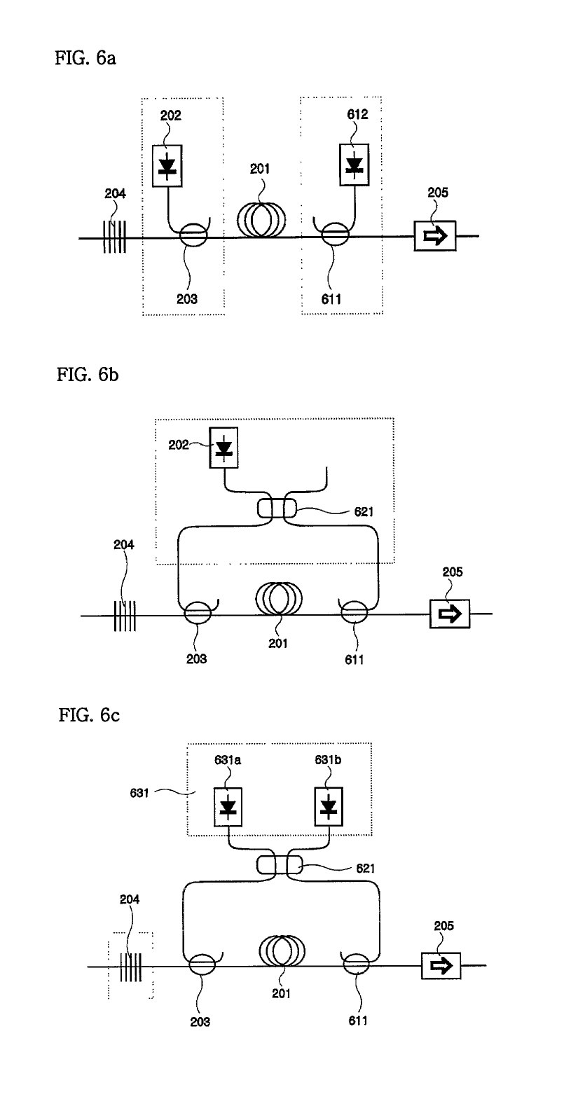

FIG. 4 shows the output characteristics of an Erbium-doped fiber laser for long wavelength band according to one embodiment of the present invention, in which the X-axis and Y-axis represent a wavelength [nm] and the strength of a laser output [dBm], respectively.

As shown in FIG. 4, it can be seen that wavelength tuning can be accomplished smoothly in long wavelength band and the value of side mode suppression ratio is above 67 dB [0.1 nm resolution] over the whole region.

From FIG. 5a to FIG. 5d show some examples of the changes in reflecting input section according to preferred embodiments of the present invention.

FIG. 5a shows the utilization of an additional coupler 211 and a reflecting mirror 212 as a reflecting means according to one embodiment of the present invention. In this case, the loss of the input laser signal for long wavelength band is minimized by keeping the tapping ratio for the reflecting mirror 212 that merges with the coupler at below 10%, which is also preferable to adjust the reflection of the backward amplified spontaneous emission to an appropriate level.

FIG. 5b shows an example of the changes in reflecting input section according to one embodiment of the present invention. A coupler 221 with a reflecting type fiber Bragg grating 222 which reflects Conventional band as a reflecting means is used.

FIG. 5c shows the use of an air gap as a reflecting means according to one embodiment of the present invention. In this case, an air gap in the shape of a capacitor reflects around 8% of a backward amplified spontaneous emission in order to re-input to the direction of the pumped EDF 201.

FIG. 5d shows the use of a liquid storage body 241 that has a refractivity as a reflecting means according to one embodiment of the present invention.

From FIG. 6a to FIG. 6c are diagrams which explain the examples of variation on the pumping laser generation section in FIG. 2.

FIG. 6a shows the inclusion of a backward pumping by adding a Wavelength Division Multiplexer 611 and a pumping laser diode 612 according to one embodiment of the present invention. This is to achieve a higher power laser in comparison to the embodiment in FIG. 2.

FIG. 6b shows a configuration which adds a Wavelength Division Multiplexer 611 and a coupler 621 according to one embodiment of the present invention. The output from the laser diode 202 is divided into two directions according to a predetermined ratio in the coupler 621 and afterwards EDF 201 is pumped in both directions. In this case, a higher amplification gain can be achieved at the pump power compared to the embodiment in FIG. 2. As a result, a more efficient laser can be constructed by using a single laser diode.

FIG. 6c shows a case in which a pumping type laser diode 631a, 631b comprises a laser diode module 631 according to one embodiment of the present invention.

The laser diode module 631 if necessary can be formed through a consolation of plurality of laser diodes in order to have a large output. In this case, the reliability of the module is very high since the module is still capable of lasing when one of the pumping laser diodes is out of operation.

From FIG. 7a to FIG. 7c are diagrams which show the changes of the filter section in FIG. 2.

It is preferable to use a band-pass filter for the filter section in the present embodiment. FIG. 7a shows a filter constructed with a Fabry-Perot interferometer 711 and it can also be constructed with Fiber Fabry-Perot filter (FFP).

FIG. 7b shows a case which uses a diffraction grating 722 by comprising a resonator as a filter section in the present embodiment. In this case, by using a circulator 721, which allows the light entered through a optical fiber connected on the right side to pass only through a optical fiber connected on the left side, the wavelength can be selected and changed by allowing only the light with a predetermined wavelength among the light exiting from the optical fiber to re-enter into the optical fiber with the diffraction grating.

FIG. 7c shows the filter section which uses the diffraction grating 722 by forming a external resonator in the present embodiment. In this case, the wavelength can be selected and changed by using a coupler 731 as the external resonator and allowing only the light with a predetermined wavelength among the light exiting from the optical fiber to re-enter into the optical fiber by using the diffraction grating.

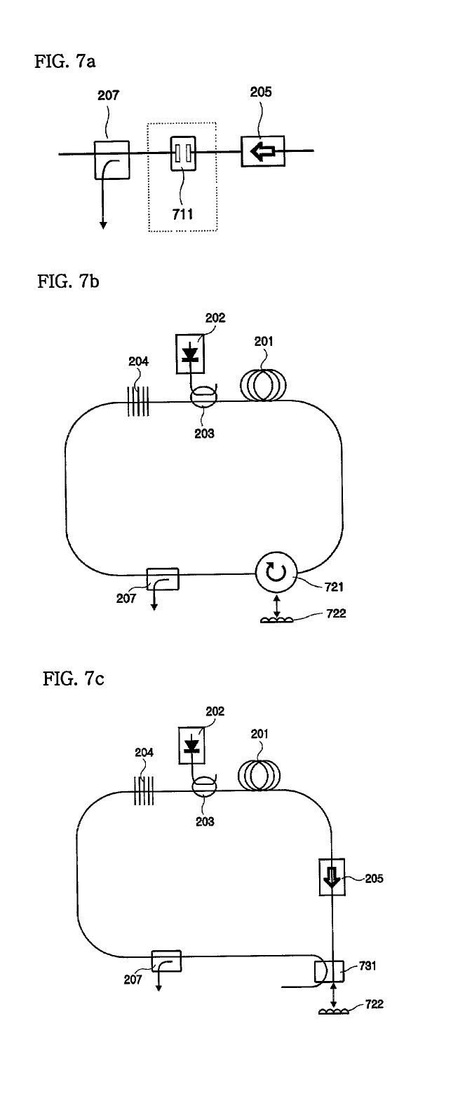

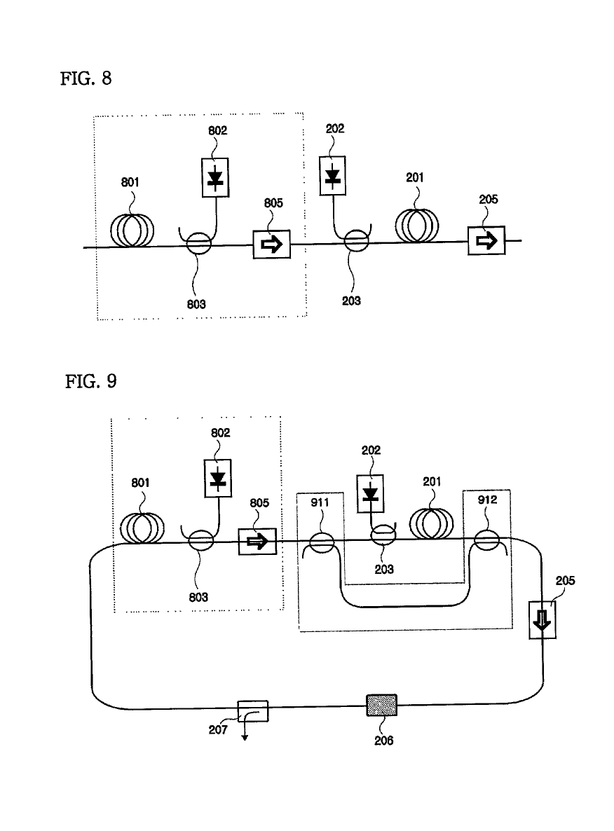

FIG. 8 is a diagram which shows an example of the construction that inputs an amplified spontaneous emission in FIG. 2.

As shown in FIG. 8, it represents a construction of directly injecting the conventional band spontaneous emission through a two stage construction instead of using a fiber Bragg grating 204. The short length EDF 501 increases the gain of long wavelength band (long wavelength band) and outputs the conventional band spontaneous emission to the second stage to improve the efficiency in the long wavelength band.

FIG. 9 is a schematic diagram which shows an Erbium-doped fiber laser for wide band according to one embodiment of the present invention.

In the two stage construction as shown in FIG. 9, the first stage uses a short length EDF for lasing in the conventional band and extra amplification in the long wavelength band. The conventional band laser only pass through Wavelength Division Multiplexers 911, 912 which take a role of separating between conventional band and long wavelength band and does not pass through the EDF in the second stage. The second stage uses a long length EDF in order to amplify the long wavelength band light and in this instance, some parts of the conventional band amplified spontaneous emission between 1560 nm to 1568 nm band are transmitted to the long wavelength band through the Wavelength Division Multiplexer 911, resulting in an increase in the efficiency. This can be understood as an example of applying the principle as explained in FIG. 8.

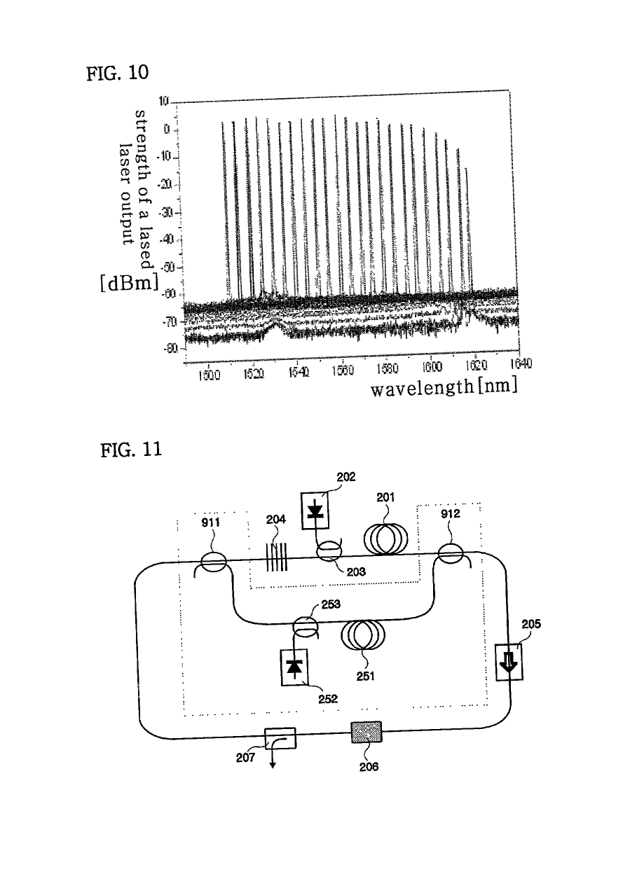

FIG. 10 shows the wavelength tuning characteristics of an Erbium-doped fiber laser for wide-band as shown in FIG. Here, the X-axis and Y-axis represent the wavelength [nm] and the strength of a lased laser output [dBm], respectively. As shown in FIG. 10, the wavelength tuning is achieved over 110 nm from 1510 nm to 1620 nm.

FIG. 11 is a schematic diagram which shows an Erbium-doped fiber laser for wide band according to other embodiment of the present invention. This is a construction of laser which lases in the range from conventional band to long wavelength band. The Wavelength Division Multiplexer 901 that takes a role of separating the conventional band signal and the long wavelength band signal in order to allow the amplification of each band. The other parts of the constructions and the principle are identical to FIG. 2.

Also, the improvement of amplification characteristics through various types of changes in the reflecting means as shown from FIG. 5a to FIG. 5d are also possible in other embodiments of the present invention such as shown in FIG. 9 and FIG. 11. Apart from the reflecting means as illustrated so far, the consolidation of other various forms of reflecting means are also possible. As explained previously, an additional number of laser diodes can be added to the construction of the laser diode module 631 for the gain improvement purpose as required. Also a laser with a good characteristic can be manufactured by allowing various changes in wavelength tuning as shown in FIG. 7a and FIG. 7b.

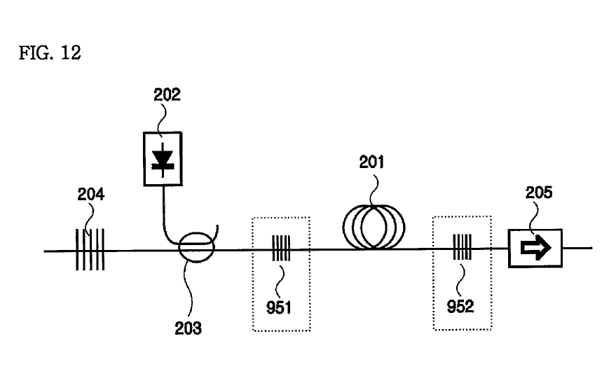

FIG. 12 is a diagram which shows an Erbium-doped fiber laser for wide band according to one embodiment of the present invention.

As shown in FIG. 12, the Erbium-doped fiber laser for Long wavelength band according to one embodiment of the present invention comprises; a EDF 201 for lasing medium; a laser diode 202 and a Wavelength Division Multiplexer 203; a fiber Bragg grating 204 for the reflecting input section; an isolator 205 for the separation transmission section; two fiber Bragg gratings 951, 952 for a linear resonators.

FIG. 12 represents the construction of the linear resonator according to one embodiment of the present invention. The construction of the linear resonator comprises added fiber Bragg gratings 951, 952. In the operation, some parts of the light are reflected at the fiber Bragg gratings and some parts of the light are outputted by passing through the fiber Bragg gratings to the isolator 205. The principle of lowering the lasing threshold by inputting the backward amplified spontaneous emission through the fiber Bragg gratings 204 at the start of lasing is identical to the construction of a ring type isolator.

Many research papers have been published on the lasers which outputs solitons or mode-locked pulses. The laser technology in the present invention can be applied to long wavelength band soliton lasers or long wavelength band mode-locked pulse lasers. In case of long wavelength band pulse lasers, a long length EDF has to be used and the pumping laser beam is absorbed at the short pump absorption length at the front part of EDF. As a result, the amplification of the long wavelength band signal is extremely low at the small signal and thus the lasing threshold increases. In this instance, if a conventional band ASE is injected, the lasing threshold decreases similarly to the continuous light source as explained previously. For example, by simply adding a fiber Bragg grating which reflects a part of the conventional band, a good quality purse laser can be manufactured.

The present invention is based on the improvement of long wavelength band amplification efficiency using the conventional band ASE injection. Obviously, modifications and alterations will occur to others upon reading and understanding the preceding detailed description. It is intended that the invention be construed as including all such modifications and alterations insofar as they come within the scope of the appended claims or the equivalents thereof.

As explained so far, the Erbium-doped fiber laser for long wavelength band according to the present invention enables the manufacturing of a fiber laser with a low threshold in long wavelength band by improving the amplification efficiency in long wavelength band through the injection of a conventional band ASE from the excited EDF to an amplification medium. This fiber laser can be useful in many areas of optical communication fields since it has a large SMSR that is greater than 65 dB.

What is claimed is:

1. An Erbium-doped fiber laser for long wavelength band, comprising:
a lasing section for lasing through a stimulated emission of an inputted laser signal;
a pumping laser generation section for population inverting said lasing section by inputting a pumping laser signal generated to said lasing section;
a reflecting input section for reflecting the conventional band amplified spontaneous emission signal inputted from said lasing section and passing as well as outputting the laser signal inputted by a feedback to said lasing section;
a separation transmission section for outputting the laser signal output from said lasing section by allowing the laser signal to pass through one direction;
a filter section for outputting a specific wavelength by filtering the specific wavelength predetermined from the laser signal inputted from said separation transmission section; and
a feedback output section for outputting the laser signal inputted from said filter section and inputting some parts of the laser signal to said reflecting input section through a feedback.

2. The Erbium-doped fiber laser as claimed in claim 1 wherein said lasing section is an Erbium-doped fiber.

3. The Erbium-doped fiber laser as claimed in claim 1 wherein said pumping laser generation section further including a laser diode for generating said pumping laser beam and a Wavelength Division Multiplexer for combining the pumping laser beam generated from said laser diode and a long wavelength band signal inputted by a feedback from said reflecting input section.

4. The Erbium-doped fiber laser as claimed in claim 1 wherein pumping laser generation section further including:
a first laser diode for generating a first pumping laser beam in order to generate said pumping laser beam;
a first Wavelength Division Multiplexer for combining the first pumping laser beam generated from said first laser diode and a long wavelength band signal inputted by a feedback from said reflecting input section;
a second laser diode for generating a second pumping laser beam in order to generate said pumping laser beam; and
a second Wavelength Division Multiplexer for inputting the second pumping laser beam generated from said second laser diode and located between said lasing section and said separation transmission section.

5. The Erbium-doped fiber laser as claimed in claim 1 wherein pumping laser generation section further including:
a laser diode for generating a pumping laser beam in order to generate said pumping laser beam;
a coupler for inputting the pumping laser beam generated from said laser diode and merging additional pumping laser input and outputting by separating said inputted pumping laser with a pre-determined ratio;
a first Wavelength Division Multiplexer for inputting the first pumping laser beam generated from said first laser diode and inputting a long wavelength band light inputted by a feedback from said reflecting input section; and
a second Wavelength Division Multiplexer for inputting the second pumping laser beam generated from said second laser diode and located between said lasing section and said separation transmission section.

6. The Erbium-doped fiber laser as claimed in claim 1 wherein reflecting input section is a fiber Bragg grating which reflects the light at a specific wavelength and passes all other wavelength.

7. The Erbium-doped fiber laser as claimed in claim 1 wherein reflecting input section merges with a reflection coupler at the rear end of said output coupler and the output of said reflection coupler is injected to said Wavelength Division Multiplexer by further including a mirror for reflecting the backward Amplified Spontaneous Emission, which is located at the opposite direction of said reflection coupler.

8. The Erbium-doped fiber laser as claimed in claim 1 wherein reflecting input section merges with a reflection coupler at the rear end of said output coupler and the output of said reflection coupler is injected to said Wavelength Division Multiplexer by further including a reflecting fiber Bragg grating for reflecting a conventional band Amplified Spontaneous Emission, which is located at the opposite direction of said reflection coupler.

9. The Erbium-doped fiber laser as claimed in claim 8, wherein said fiber Bragg grating is located between the Wavelength Division Multiplexer and the long length Erbium-Doped Fiber.

10. The Erbium-doped fiber laser as claimed in claim 1 wherein reflecting input section is a capacitor type air gap which faces each other.

11. The Erbium-doped fiber laser as claimed in claim 1 wherein reflecting input section is a liquid storage body with a refractivity which faces each other.

12. The Erbium-doped fiber laser as claimed in claim 1 wherein said separation transmission section is an isolator which outputs laser signal to one direction from said lasing section.

13. The Erbium-doped fiber laser as claimed in claim 1 wherein said filter section is a band-pass filter which outputs only the light of the required wavelength among the input light in order to make it lase.

14. The Erbium-doped fiber laser as claimed in claim 1 wherein said filter section uses a Fabry-Perot interferometer to change the wavelength.

15. The Erbium-doped fiber laser as claimed in claim 1 wherein said filter section uses a Fiber Fabry-Perot filter (FFP) to change the wavelength.

16. The Erbium-doped fiber laser as claimed in claim 1 wherein said filter section further including:
a diffraction grating for executing a pre-determined external resonating by outputting the light of a pre-determined wavelength among inputted light to the optical fiber; and
a circulator for receiving the laser signal from said separation transmission section and outputting the signal of a pre-determined wavelength through filtering of a pre-determined wavelength by receiving externally resonated signal from said diffraction grating.

17. The Erbium-doped fiber laser as claimed in claim 1 wherein said filter section further including:
a diffraction grating for executing a pre-determined external resonating by outputting the light of a pre-determined wavelength among inputted light to the optical fiber; and
a coupler for receiving the signal laser signal from said separation transmission section and outputting tunable wavelength through filtering of a predetermined wavelength by receiving externally resonated signal from said diffraction grating.

18. The Erbium-doped fiber laser as claimed in claim 1 wherein said feedback output section is a coupler which outputs a pre-determined portion of a long wavelength band light outputted from said filter section and feeds back the rest of the long wavelength band light into said reflection input section.

19. The Erbium-doped fiber laser as claimed in claim 1 wherein said reflection input section further including:
an Erbium-doped fiber for providing the amplification gain in said long wavelength band and combined to the rear end of said feedback output section;
a pumping laser diode for outputting the pump laser signal to generate population inversion in said erbium-doped fiber;
a Wavelength Division Multiplexer for receiving a pumping laser from said pumping laser diode and on the other side, receiving a laser signal from said Erbium-doped fiber; and
an isolator for outputting a laser signal from said Wavelength Division Multiplexer to one direction.

20. The Erbium-doped fiber laser as claimed in claim 1, further including:
a first Wavelength Division Multiplexer for separating a conventional band laser input from said reflection input section and located at the front end of said pumping laser generation section; and
a second Wavelength Division Multiplexer for outputting a long wavelength band laser beam from said lasing section by merging it with a conventional band laser beam which is separately outputted from said first Wavelength Division Multiplexer.

21. The Erbium-doped fiber laser as claimed in claim 1, further including:
a first Wavelength Division Multiplexer for separating a Conventional band laser input from said feedback output section and located at the front end of said pumping laser generation section;
a laser diode for generating a pumping laser beam for long wavelength band;
a Wavelength Division Multiplexer for receiving a pumping laser from said pumping laser diode and on the other side, receiving a conventional band laser signal along with a long wavelength band laser signal from said first Wavelength Division Multiplexer;
an Erbium-doped fiber for increasing the gain of said long wavelength band by amplifying the light outputted from said Wavelength Division Multiplexer for long wavelength band; and
a second Wavelength Division Multiplexer for outputting a lased laser from said lasing section by merging it with a laser which is separately outputted from said Erbium-doped fiber laser.

22. The Erbium-doped fiber laser as claimed in claim 20, further including:
a first Wavelength Division Multiplexer for separating a Conventional band laser input from said feedback output section and located at the front end of said pumping laser generation section;
a laser diode for generating a pumping laser beam for long wavelength band;
a Wavelength Division Multiplexer for receiving a pumping laser from said pumping laser diode and on the other side, receiving a conventional band laser signal along with a long wavelength band laser signal from said first Wavelength Division Multiplexer;
an Erbium-doped fiber for increasing the gain of said long wavelength band by amplifying the light outputted from said Wavelength Division Multiplexer for long wavelength band; and
a second Wavelength Division Multiplexer for outputting a lased laser from said lasing section by merging it with a laser which is separately outputted from said Erbium-doped fiber laser.

23. The Erbium-doped fiber laser as claimed in claim 1 wherein said laser is a soliton laser for long wavelength band.

24. The Erbium-doped fiber laser as claimed in claim 1 wherein said laser is a pulse laser for long wavelength band.

25. An Erbium-doped fiber laser for long wavelength band, comprising:
a lasing section for lasing through a stimulated emission of an inputted laser signal;
a pumping laser generation section for population inverting said lasing section by inputting a pumping laser beam generated to said lasing section;
a first linear resonator mirror located at the front end of said pumping laser generation section;
a second linear resonator mirror located at the rear end of said pumping laser generation section;
a reflecting input section for reflecting a conventional band Amplified Spontaneous Emission input from said lasing section and re-inputting it;
a separation transmission section for outputting a long wavelength band laser output generated by lasing from said lasing section by allowing the laser signal to pass through one direction; and
wherein said first linear resonator mirror and second linear resonator mirror resonate in pair for said lasing.
